(19) United States
(12) Patent Application Publication
(10) Pub. No.: US 2017/0057467 A1
(43) Pub. Date: Mar. 2, 2017

(54) DETECTION DEVICE CLEANING APPARATUS HAVING VENTILATING PASSAGE

(71) Applicant: DENSO CORPORATION, Kariya-city (JP)

(72) Inventor: Masaya TANAKA, Ann Arbor, MI (US)

(21) Appl. No.: 14/836,138

(22) Filed: Aug. 26, 2015

(51) Int. Cl. B60S 1/54; B60S 1/56

(52) U.S. Cl. CPC B60S 1/54; B60S 1/56

(57) ABSTRACT

A housing has an inner wall defining an inner aperture, an outer wall defining an outer aperture, and an inlet having an inlet opening. The inner aperture and the outer aperture are aligned with other to form an optical path. A shield is non-opaque and is located on the optical path. The housing forms an inner channel to draw air from the inlet opening to pass around the shield toward the outer aperture.

### TECHNICAL FIELD

The present disclosure relates to a detection device cleaning apparatus.

### BACKGROUND

Conventionally, a detection device may be installed on a vehicle for detecting an external condition of the vehicle. A detection device may be an imaging device such as a camera, a millimeter-wave radar, or a laser radar. Such a detection device may be exposed to the weather to result in deposition of debris. Consequently, such deposition of debris may degrade performance of the detection device. A detection device may be employed in an automated vehicle. In such a case, degradation of the detection device may exert adverse effect on a safety operation of the automated vehicle.

### SUMMARY

According to an aspect of the preset disclosure, a housing may have an inner wall defining an inner aperture, an outer wall defining an outer aperture, and an inlet having an inlet opening. The inner aperture and the outer aperture may be aligned with other to form an optical path. A shield may be non-opaque and being located on the optical path. The housing may form an inner channel configured to draw air from the inlet opening to pass around the shield toward the outer aperture. The inlet opening may have an inlet opening area A1. The outer aperture may have an outer aperture area A2. The outer aperture area A2 may be less than the inlet opening area A1.

### BRIEF DESCRIPTION OF THE DRAWINGS

The above and other objects, features and advantages of the present invention will become more apparent from the following detailed description made with reference to the accompanying drawings. In the drawings:

FIG. 1 is a perspective view showing a detection device system;

FIG. 2 is a front view showing the detection device system;

FIG. 3 is a partial perspective view showing the detection device system;

FIG. 4 is a partial side view showing the detection device system;

FIG. 5 is a partial side view showing a detection device system according to a second embodiment;

FIG. 6 is a partial side view showing a detection device system according to a third embodiment;

FIG. 7 is a partial side view showing a detection device system according to a fourth embodiment;

FIG. 8 is a partial side view showing a detection device system according to a fifth embodiment;

FIG. 9 is a partial perspective view showing the detection device system according to the fifth embodiment; and

FIG. 10 is a front view showing the detection device system according to the fifth embodiment.

### DETAILED DESCRIPTION

### First Embodiment

As follows, a first embodiment of the present disclosure will be described with reference to drawings. In the description, a vertical direction is along an arrow represented by “VERTICAL” in drawing(s). A lateral direction is along an arrow represented by “LATERAL” in drawing(s). An axial direction is along an arrow represented by “AXIAL” in drawing(s).

### First Embodiment

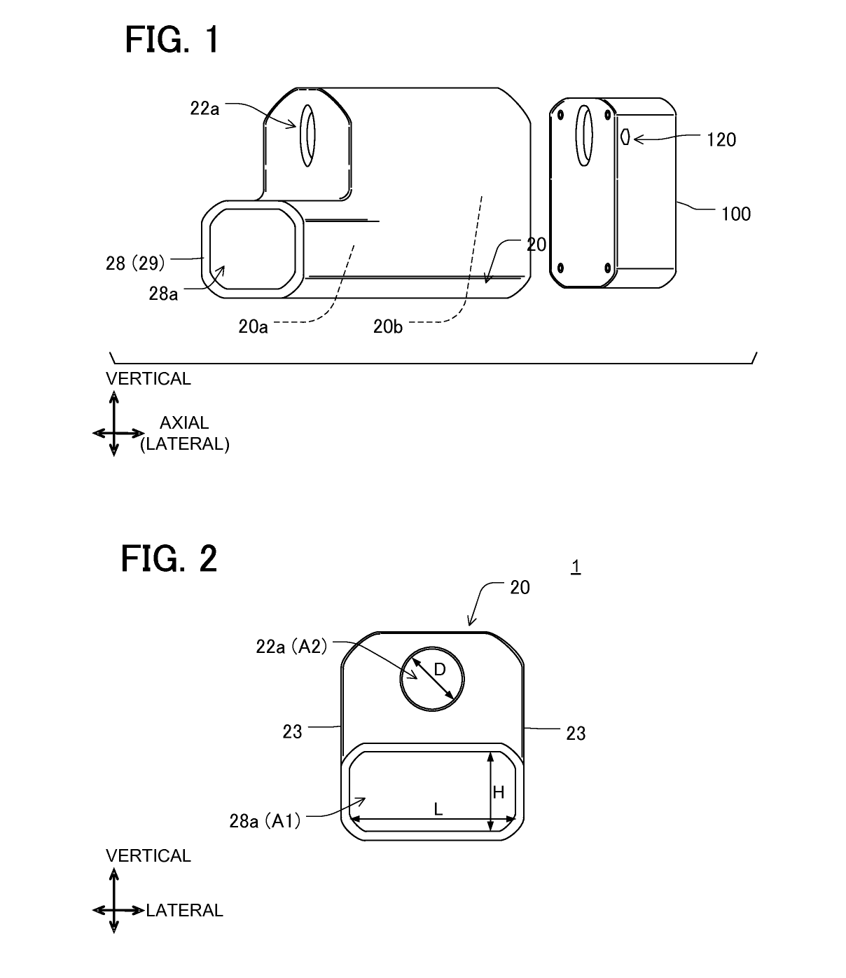

The first embodiment will be described with reference to FIGS. 1 to 4. A detection device system includes an imaging device 100 and a detection device cleaning apparatus 1, which accommodates the imaging device 100. The detection device system may be mounted on an exterior of a vehicle such as an automotive. The imaging device 100 may be one example of a detection device.

More specifically, the detection device system may be mounted to the vehicle such that a front surface of an imaging device 100 is directed to the front of the vehicle. The device may be installed at various positions in the vehicle such as a front bumper, a front grill, a side mirror, an engine hood, and/or a roof, such that the vertical direction of the device is along the direction of gravity.

The imaging device is, for example, a camera having an electronic imaging element 120 such as a charge coupled device (CCD) accommodated in a case. The imaging device may employ various configurations to detect moving picture and/or still picture in color. The imaging device may be connected to an electronic control unit (ECU: not shown) of the vehicle to send detected images to the ECU. The imaging element 120 may be one example of a detection element.

The detection device cleaning apparatus 1 includes a housing 20. The housing 20 may be formed of a weather-resistive material. Specifically, the weather-resistive material may be metal such as aluminum and/or resin such as polycarbonate.

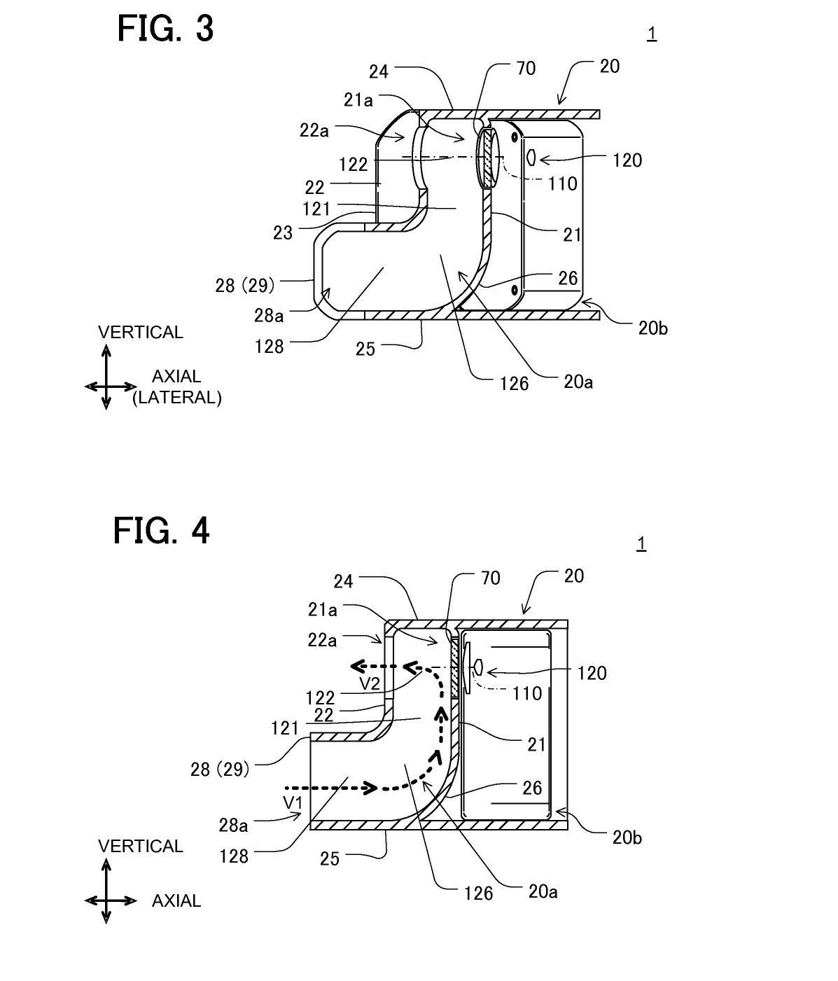

In FIG. 1, the housing 20 is, for example, a box-shaped hollow member. The housing 20 may be configured to accommodate the camera 100. In FIG. 3, the housing 20 may have an inner wall 21, an outer wall 22, sidewalls 23, an upper wall 24, a lower wall 25, and a bent wall 26. The sidewalls 23, the upper wall 24, and the lower wall 25 may form four sides of the housing 20. The outer wall 22 may cover an upper area of the housing 20 on the front side.

The housing 20 may further have an inlet 28. The inlet 28 may be protruded from a lower region of the housing 20 toward the front side. The inner wall 21 may partition an internal space of the housing 20 into an inner channel 20a and an accommodation space 20b. The inner wall 21 defines an inner aperture 21a. The outer wall 22 defines an outer aperture 22a. The inner aperture 21a and the outer aperture 22a are aligned with other to form an optical path 110. The optical path 110 may be one example of a detection path.

The bent wall 26 may be extended from the inner wall 21 downward and may be bent toward the front side. The bent wall 26, the outer wall 22, and the sidewalls 23 may be connected with the inlet 28. The inlet 28 may be in a tubular shape. The inlet 28 may have inlet walls 29. The inlet walls 29 may form four sides of the inlet 28 and may define an inlet opening 28a and an inlet passage 128. The inlet passage 128 may extend from the inlet opening 28a though the inlet 28. The inner wall 21 and the outer wall 22 may form an intermediate passage 121 therebetween in the housing 20 at a position excluding the inner aperture 21a and the outer aperture 22a.

The bent wall 26 partially forms a bent passage 126 between the inlet passage 128 and the intermediate passage 121. The bent passage 126 may be a curved passage bent at an angle and may communicate the inlet passage 128 with the intermediate passage 121.

An outlet passage 122 may be formed between the inner aperture 21a and the outer aperture 22a in the housing 20 and may be communicated with the outer aperture 22a. The outlet passage 122 may communicate with the inlet passage 128 through the intermediate passage 121 and the bent passage 126.

The inner channel 20a formed in the housing 20 may include the inlet passage 128, the bent passage 126, the intermediate passage 121, and the outlet passage 122 in this order. The inner channel 20a may be in a U-shape to receive air from the inlet opening 28a. The inner channel 20a may further draw the air through the inlet passage 128 and may bend a flow direction of the air at an angle through the bent passage 126. The inner channel 20a may further draw the air through the intermediate passage 121 and may further guide the air toward the outlet passage 122. The inner channel 20a may further bend the flow direction of the air at an angle around the outlet passage 122 and may direct the air to the outlet passage 122. In this way, the inner channel 20a may direct the flow direction of air at the outer aperture 22a in the opposite direction from the flow direction of the air in the inlet opening 28a.

In the example, the inlet passage 128 may be perpendicular to the intermediate passage 121. The intermediate passage 121 may be perpendicular to the optical path 110. The outlet passage 122 may be perpendicular to the intermediate passage 121. The outlet passage 122 may be along the optical path 110.

In FIG. 2, the inlet opening 28a has an inlet opening area A1, and the outer aperture 22a has an outer aperture area A2. Specifically, the inlet opening 28a may be in a chamfered rectangular shape having the height H and the length L, and the inlet opening area A1 may be calculated roughly by (L×H). The outer aperture 22a may in a circular shape having a diameter D, and the outer aperture area A2 may be calculated by (PI×(D×D)/4).

For example, as the vehicle travels, ram air may occur to pass by the vehicle and the detection device cleaning apparatus 1. The ram air may pass through the inner channel 20a inside the housing 20. In the example, the outer aperture area A2 may be set to be less than the inlet opening area A1. In this case, the ram air may enter the inlet opening 28a, may pass through the inner channel 20a, and may flow out of the outer aperture 22a. Specifically, the ram air may pass through the inlet opening 28a at an inlet flow velocity V1. The ram air may pass through the outer aperture 22a at an outlet flow velocity V2. The relation among the inlet opening area A1, the outer aperture area A2, the inlet flow velocity V1, and the outlet flow velocity V2 may be represented by the following equation of continuity: (A1×V1)=(A2×V2). In the example, the outer aperture area A2 may be set to be less than the inlet opening area A1. Therefore, according to the equation of continuity, the outlet flow velocity V2 may be greater than the inlet flow velocity V1. Therefore, airstream of the ram air may occur from the inlet opening 28a at the lower inlet flow velocity V1 toward the outer aperture 22a at the higher flow velocity V2.

In FIGS. 3 and 4, a shield 70 may be in a disc shape or in a sheet shape. The shield 70 may be a non-opaque member formed of a light transmissive material such as glass and/or acrylic resin. The shield 70 may be transparent to allow light to pass therethrough. The shield 70 may be located on the optical path 110 and may be equipped in the inner aperture 21a.

Alternatively, the shield may be a lens in a convex shape and may be combined with the imaging element 120 of the camera 100 to function as a primal or secondary optical magnifier.

The outer aperture 22a and the inner aperture 21a may be aligned with each other and may be overlapped one another along the axial direction. Thus, the outer aperture 22a and the inner aperture 21a may define the optical path 110 extending along the axial direction. The optical path 110 may extend through the shield 70, which is a non-opaque object. The shield 70 may cover the inner aperture 21a to protect the inner aperture 21a from foreign matters such as debris. Simultaneously, the shield 70 may permit light to pass along the optical path 110 through the outer aperture 22a and the shield 70 in the inner aperture 21a.

The camera 100 may be accommodated in the accommodation space 20b in the housing 20. The camera 100 may be affixed to the inner wall 21 of the housing 20 by using, for example, fasteners such as screws. The imaging element 120 of the camera 100 may be aligned with the optical path 110. Thus, the shield 70 may permit the camera 100 to conduct imaging along the optical path 110 through the shield 70, while protecting the camera 100 from foreign matters.

In the example of FIG. 4, as shown by dotted arrows, as the vehicle travels, ram air may occur to create an airstream to pass through the inlet opening 28a and the inlet passage 128 and may change in the flow direction through the bent passage 126. The airstream may further pass through the intermediate passage 121 in the vertical direction and may further change in the flow direction toward the outlet passage 122 while passing around the shield 70. Thus, the air may be guided to pass through the outer aperture 22a. The airstream may be caused by air and/or may be caused by wind.

In this way, the inner channel 20a may be configured to draw air from the inlet opening 28a to pass around the shield 70 toward the outer aperture 22a. In this example, the airstream may apply hydraulic force onto debris deposited on the shield 70 to blow the debris. The airstream may ventilate the inner channel 20a to blow debris and moisture in the inner channel 20a.

### Second Embodiment

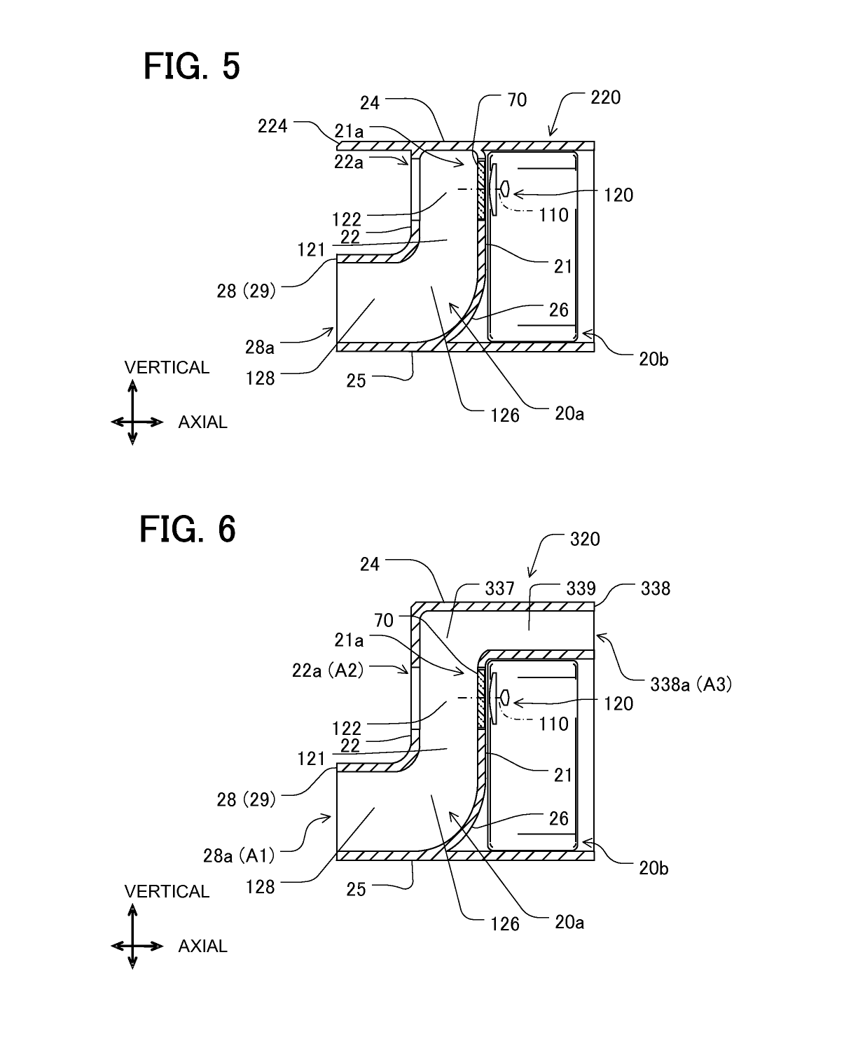

As shown in the example of FIG. 5, a housing 220 may further have a roof 224 protruded from an end of the housing 20 on an upper side of the outer aperture 22a. The roof 224 may extend from the upper wall 24 of the housing 220 along the optical path 110. The roof 224 may be in a plate shape. The roof 224 may restrict foreign matters such as debris from intruding through the outer aperture 22a into the inner channel 20a.

The housing 20 may have a tubular wall extending from a periphery of the outer wall 22. Specifically, the upper wall 24 and the sidewalls 23 may be extended toward the front side to form the tubular wall. The roof 224 may be a part of the tubular wall.

### Third Embodiment

As shown in the example of FIG. 6, a housing 320 may further have an exhaust 338 being in a tubular shape. The exhaust 338 may have an exhaust opening 338a and may define an exhaust passage 339. The exhaust passage 339 may extend from the exhaust opening 338a though the exhaust 338.

The exhaust passage 339 may communicate with the inlet opening 28a through the inner channel 20a and a bent passage 337. The exhaust passage 339 may be branched from the inner channel 20a through the bent passage 337. The exhaust opening 338a may be directed in a rearward direction toward a rear side. The rearward direction of the exhaust opening 338a may be opposite from a forward direction in which the inlet opening 28a is directed toward the front side.

The exhaust opening 338a may be throttled to have a narrow width and may have an exhaust opening area A3. The outer aperture area A2 of the outer aperture 22a may be less than both the exhaust opening area A3 of the exhaust opening 338a and the inlet opening area A1 of the inlet opening 28a. The exhaust opening area A3 of the exhaust opening 338a may be less than or equal to the inlet opening area A1 of the inlet opening 28a.

Alternatively, the exhaust opening area A3 of the exhaust opening 338a may be less than both the inlet opening area A1 of the inlet opening 28a and the outer aperture area A2 of the outer aperture 22a. Sum of the exhaust opening area A3 of the exhaust opening 338a and the outer aperture area A2 of the outer aperture 22a may be less than the inlet opening area A1 of the inlet opening 28a.

The exhaust opening 338a may create an additional quantity of airflow from the inlet 28 and may enhance ventilation of the inner channel 20a.

In the embodiment, the outer aperture area A2 of the outer aperture 22a may be zero. Specifically, the outer aperture 22a may be equipped with a non-opaque object such as a lens and/or a shield. In this case, the non-opaque object may prohibit airflow therethrough, while permitting the optical path 110 to pass therethrough.

### Fourth Embodiment

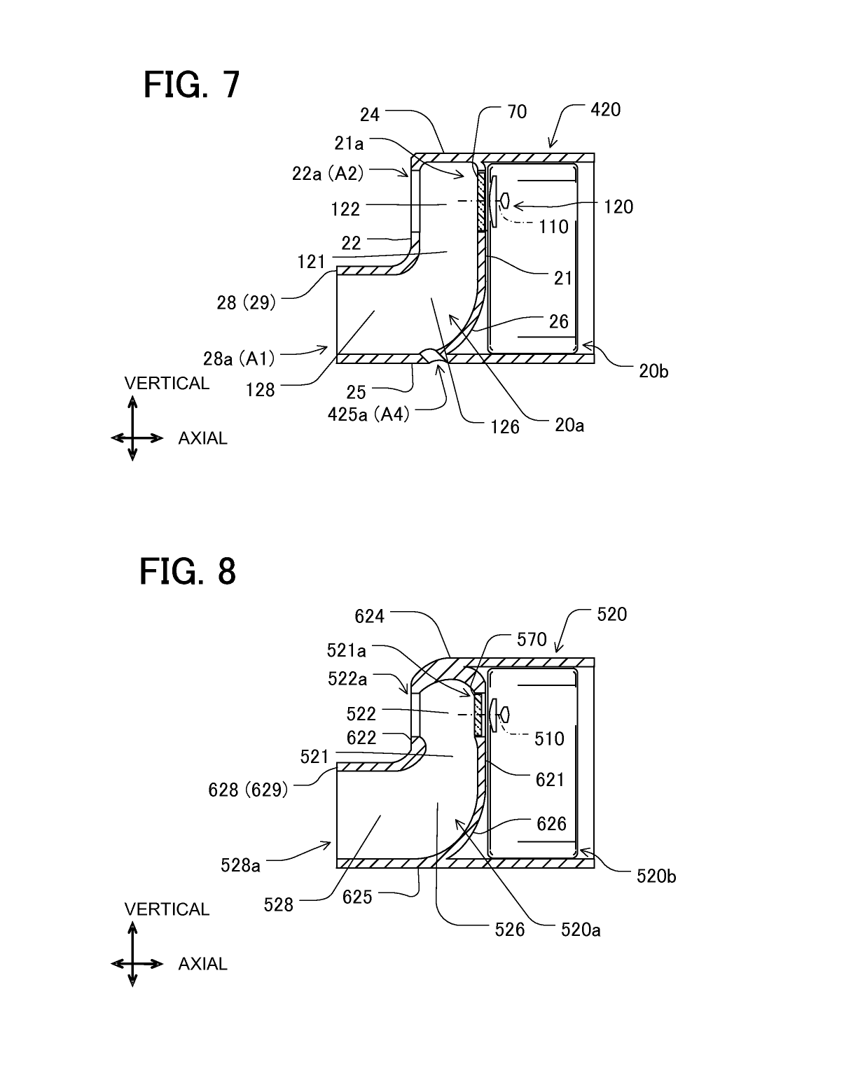

As shown in the example of FIG. 7, the lower wall 25 of the housing 20 may have a drain hole 425a. The drain hole 425a may be a through hole extending through the lower wall 25 in the thickness direction of the lower wall 25. The drain hole 425a may be at an angle relative to the vertical direction and may be inclined to along with the flow direction of air through the inner channel 20a. The drain hole 425a may enable to discharge foreign matters entering through the inlet opening 28a into the inner channel 20a. The drain hole 425a may have a drain hole area A4, which may be less than both the inlet opening area A1 of the inlet opening 28a and the outer aperture area A2 of the outer aperture 22a.

### Fifth Embodiment

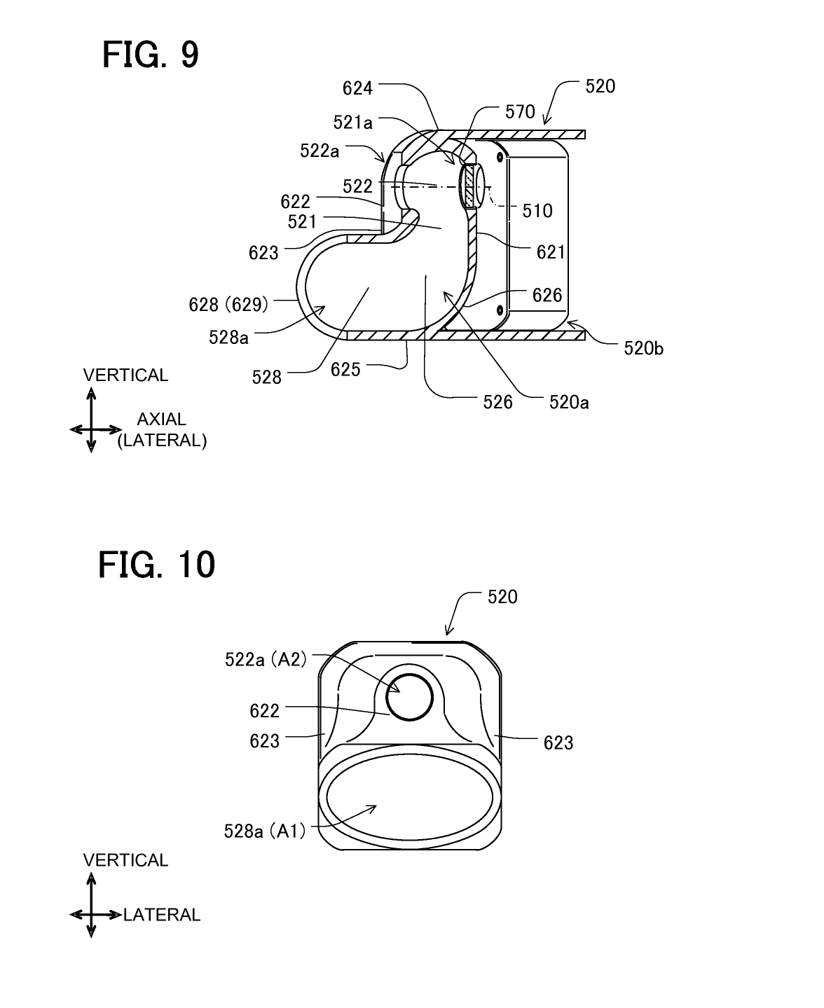

As shown in the example of FIGS. 8 to 10, a housing 520 may have curved walls including an inner wall 621, an outer wall 622, sidewalls 623, an upper wall 624, a lower wall 625, and a bent wall 626. The sidewalls 623, the upper wall 624, and the lower wall 625 may form four round sides of the housing 520. The inner wall 621 may partition an internal space of the housing 520 into an inner channel 520a and an accommodation space 520b.

The inner wall 621 defines an inner aperture 521a. The outer wall 622 defines an outer aperture 522a. The inner aperture 521a and the outer aperture 522a are aligned with other to form an optical path 510. In the example, the inner aperture 521a and the outer aperture 522a may be smaller than those in the first to fourth embodiments.

The inlet 628 may be in a tubular shape having a circular cross section or an oval cross section. The inlet 628 may have inlet walls 629 defining an inlet opening 528a and an inlet passage 528 each having an oval cross section. An inner channel 520a may be in a rounded U-shape to receive air from the inlet opening 528a. The inner channel 520a formed in the housing 520 may include an inlet passage 528, a bent passage 526, an intermediate passage 521, and an outlet passage 522 in this order. In the example, the inner passage 520a may be reduced in area from the inlet 628 toward the outer aperture 522a. Specifically, for example, the inlet passage 528, the bent passage 526, the intermediate passage 521, the outlet passage 522, and the outer aperture 522a may be gradually reduced in area in this order. The outer wall 622 may have a convex cross section protruded into the intermediate passage 521. The upper wall 624 may have a rounded cross section to form the outlet passage 522 in a round shape.

In FIG. 10, the outer wall 622 may have a rounded portion defining a part of the inner channel 520a to reduce the area from the intermediate passage 521 toward the outer aperture 522a on the downstream side.

In the example, the housing 520 may define a continually throttled tube to define the inner channel 520a. In the continually throttled tube, the inner channel 520a may gradually reduce in area from the inlet passage 528 to the outlet passage 539.

### Other Embodiment

The above-described configurations may be employed in various devices other than an imaging device. For example, the configurations may be employed in a millimeter-wave radar and/or a laser radar.

In the above-described embodiments, at least one of the inlet opening 28a and 528a, the outer aperture 22a and 522a, and the exhaust opening 338a may be equipped with a filter. The filter may be, for example, a mesh formed of resin and/or metal such as a nonwoven fabric and/or a steel wire. The filter may prohibit foreign matters from intruding into the housing and may protect the detection device.

The shield may be applied with nano-coating to enhance cleaning effect.

The components described in the above-described embodiments may be arbitrarily combined and/or omitted. For example, the roof in the second embodiment, the exhaust passage in the third embodiment, the drain hole in the fourth embodiment, and/or the continually throttled tube in the fifth embodiment may be applied to another embodiment arbitrarily.

It should be appreciated that while the processes of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A detection device cleaning apparatus comprising:
a housing having an inner wall defining an inner aperture, an outer wall defining an outer aperture, and an inlet having an inlet opening, the inner aperture and the outer aperture being aligned with other to form an optical path; and
a shield being non-opaque and being located on the optical path, wherein
the housing forms an inner channel configured to draw air from the inlet opening to pass around the shield toward the outer aperture,
the inlet opening has an inlet opening area A1,
the outer aperture has an outer aperture area A2, and
the outer aperture area A2 is less than the inlet opening area A1.

2. The detection device cleaning apparatus of claim 1, wherein
the inlet opening defines an inlet passage,
the housing forms an intermediate passage between the inner wall and the outer wall,
the housing further forms an outlet passage between the inner aperture and the outer aperture,
the outlet passage communicates with the inlet passage through the intermediate passage, and
the inner channel includes the outlet passage, the intermediate passage, and the inlet passage.

3. The detection device cleaning apparatus of claim 1, wherein
the shield is located in the inner aperture, and
the inner aperture and the outer aperture are opposed to each other on the optical path.

4. The detection device cleaning apparatus of claim 2, wherein
the inner channel is in a U-shaped to receive air from the inlet opening and to direct the air through the outlet passage in an opposite direction.

5. The detection device cleaning apparatus of claim 2, wherein
the inlet passage is perpendicular to the intermediate passage.

6. The detection device cleaning apparatus of claim 2, wherein
the outlet passage is perpendicular to the intermediate passage.

7. The detection device cleaning apparatus of claim 2, wherein
the outlet passage extends along the optical path, and
the intermediate passage is perpendicular to the optical path.

8. The detection device cleaning apparatus of claim 1, wherein
the housing has an accommodation space to accommodate a detection device, and
the accommodation space is configured to accommodate the detection device such that a detection element of the detection device is aligned with the optical path.

9. The detection device cleaning apparatus of claim 1, wherein
the housing further has a roof protruded from an end of the housing on an upper side of the outer aperture, and
the roof extends along the optical path.

10. The detection device cleaning apparatus of claim 1, wherein
the housing further has an exhaust having an exhaust opening and defining an exhaust passage,
the exhaust passage communicates with the inlet opening through the inner channel,
the exhaust passage is branched from the inner channel, and
the exhaust opening is directed in a direction opposite from a direction in which the inlet opening is directed.

11. The detection device cleaning apparatus of claim 10, wherein
the inlet opening has an inlet opening area A1,
the outer aperture has an outer aperture area A2,
the exhaust opening has an exhaust opening area A3,
the outer aperture area A2 is less than both the exhaust opening area A3 and the inlet opening area A1, and
the exhaust opening area A3 is less than or equal to the inlet opening area A1.

12. The detection device cleaning apparatus of claim 1, wherein
the housing has a drain hole, which is a through hole extending through a lower wall of the inner channel.

13. The detection device cleaning apparatus of claim 1, wherein
the housing forms a continually throttled tube to define the inner channel, and
the inner channel gradually reduces in area from the inlet passage to the outlet passage.
